(19) United States
(12) Patent Application Publication
(10) Pub. No.: US 2021/0159645 A1
(43) Pub. Date: May 27, 2021

(54) SWITCHED PLUG

(71) Applicant: CARESTREAM HEALTH, INC., Rochester, NY (US)

(72) Inventors: Martin E. TRZCINSKI, Rochester, NY (US); William F. SNYDER, Hilton, NY (US)

(21) Appl. No.: 16/690,322

(22) Filed: Nov. 21, 2019

(51) Int. Cl. H01R 13/703; H01R 13/70; H01R 24/28; H01R 13/641

(52) U.S. Cl. CPC H01R 13/7036; H01R 13/701; H01R 2103/00; H01R 13/641; H01R 24/28

(57) ABSTRACT

An electric plug having a switch for coupling a cable to a source of electric power. Electrically conductive prongs are configured to be coupled to the source of electric power when conductive prongs are inserted into an electric power outlet. A switch disposed within the plug electrically couples the plurality of prongs to the cable only after the prongs are electrified by the source of electric power.

### BACKGROUND OF THE INVENTION

The subject matter disclosed herein relates to electrical connectors, in particular, to an electric plug having a switch to control energizing a cable when the plug is inserted into an electric power outlet.

### BRIEF DESCRIPTION OF THE INVENTION

Some electrical devices generate sparks between an electric plug and an electric power outlet when they are plugged or unplugged. This is especially true when a plugged device is drawing power at a designed maximum level from the electric power outlet. Because it is inconvenient to turn off an AC circuit breaker before plugging a device into, or unplugging a device from, an electric power outlet, it is advantageous to use a plug assembly that switches off power at the plug before the blades of the plug and electric power outlet are disengaged.

An electric plug includes a switch for coupling a cable to a source of electric power, e.g., a standard electric power outlet. Electrically conductive prongs are configured to be electrically coupled to the electric power outlet when the prongs are inserted therein. A switch disposed within the plug electrically couples the plurality of prongs to the cable only after the prongs are electromechanically engaged with the electric power outlet. An advantage that may be realized in the practice of some disclosed embodiments of the switched plug is to prevent sparking at an electric power outlet when the plug is disengaged from or inserted into the electric power outlet.

In one embodiment, an electric plug includes a housing and a cable attached to the housing. A plurality of electrically conductive prongs extend from the housing and each are configured to be electrically coupled to the cable and to a source of electric power when the prongs are inserted into an electric power outlet. A switch disposed within the housing electrically couples and decouples at least one of the plurality of prongs to and from the cable.

In another embodiment, an electric plug includes a housing, a plurality of conductive prongs and a plunger extending from the housing, a cable attached to and extending from the housing, and a switch disposed within the housing attached to the plunger. The prongs are fixed to the housing while the plunger is movable into and out of the housing. The prongs extend further from the housing than the plunger, and the switch electrically couples the plurality of conductive prongs to the cable when the plunger is moved into the housing, and electrically decouples the plurality of conductive prongs from the cable when the plunger is moved away from, or out of, the housing.

In one embodiment, the plug may include a Hubbell HBL8115V hospital grade plug, an SAIA-Burgess XP52Z11 switch, and a Visual Communication 2150A3 neon light source to indicate that the switch is electrically engaged and that electric power is present. The final assembly would be 94V0 rated.

The summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings below are intended to be drawn neither to any precise scale with respect to relative size, angular relationship, relative position, or timing relationship, nor to any combinational relationship with respect to interchangeability, substitution, or representation of a required implementation., emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIGS. 1A and 1B are perspective views of the switched plug;

FIG. 2 is a schematic diagram of the switched plug; and

FIG. 3 is a wall outlet or receptacle.

### DETAILED DESCRIPTION OF THE INVENTION

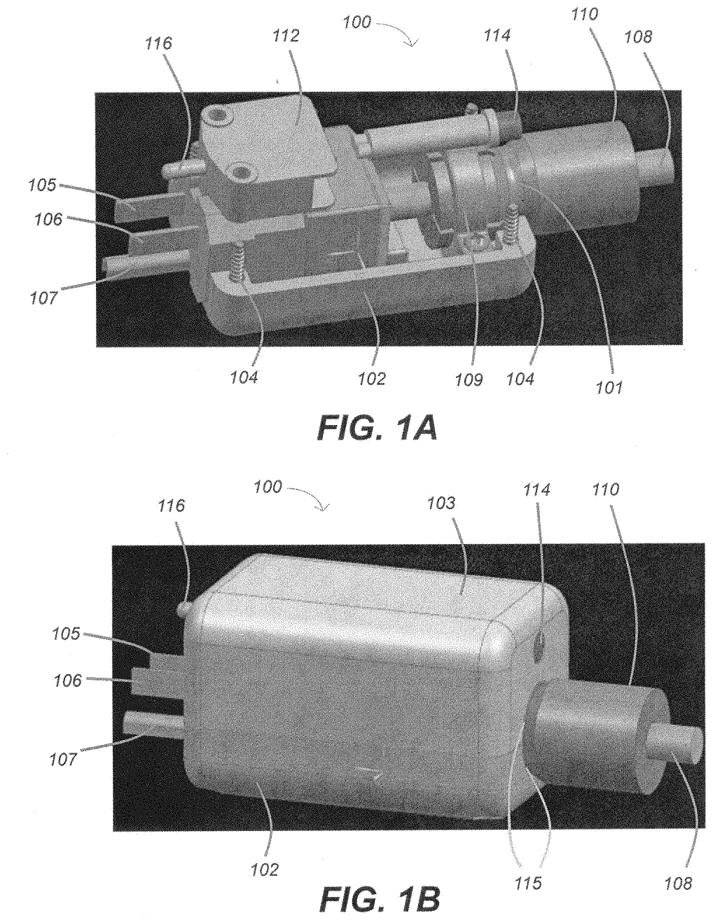

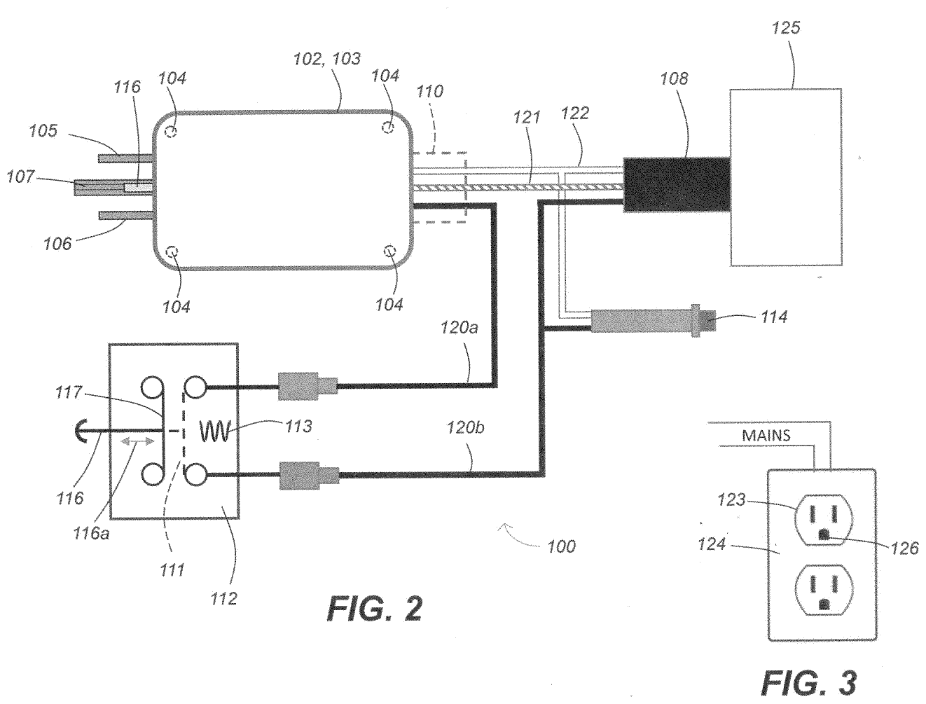

With reference to FIGS. 1A, 1B, 2 and 3, an electric plug 100 includes prongs, or blades, 105, 106, 107, that are designed to be manually inserted into an electric power outlet or receptacle 123 (FIG. 3) to transmit electric power provided by a power source MAINS of the electric power outlet 123 over an electrically conductive cable 108 to an electrically powered device 125 electrically connected to the cable 108. The plug 100 may include a two piece housing having a bottom piece 102 securely fixed to a top piece 103 using a plurality of screws 104. The two piece housing 102, 103, encloses several components of the plug 100 while other components extend from the housing, as described herein. The prongs 105-107, are preferably formed such that prongs 105, 106, are substantially equivalent in length while prong 107 is longer than the prongs 105, 106. Thus, the prong 107 extends further from the housing 102, 103, than the prongs 105, 106, as shown in FIG. 2. The prongs 105-107 are preferably fixably attached to the housing 102, 103, such that the prongs are not movable relative thereto.

The longest prong 107 may preferably be electrically connected to a ground wire 121 within the housing 102, 103, of plug 100. The prongs 105, 106, may each be electrically connected to one of a neutral wire 122 and a hot wire 120a within the housing 102, 103, of plug 100. Because the prong 107 is longer than the prongs 105, 106, the prong 107 will electrically connect to a ground receptacle 126 of electric power outlet 123 before the prongs 105, 106, electrically connect to power receptacles of electric power outlet 123 when the prongs 105-107 are manually inserted into electric power outlet 123. The hot wire, or conductor, 120a, the ground wire, or conductor, 121, and the neutral wire, or conductor, 122, are tightly enclosed by a flexible insulating, or dielectric, tube to form cable 108. The cable 108 may be secured to the housing 102, 103, by a relatively stiff yet flexible shock absorber 110. The shock absorber 110 may be formed as a tube of varying diameter enclosing a portion of the cable 108 as the cable 108 passes from an interior of the housing 102, 103, to an exterior thereof. The shock absorber 110 acts as a stress relief mechanism for the cable 108. The shock absorber includes an annular indent 101 that fits within a circular opening of the housing 102, 103, formed by a semicircular recess 115 in each of the top and bottom housing pieces 102, 103, which secures in position the shock absorber 110 and the cable 108 therewithin relative to the housing 102, 103. The shock absorber 110 is also secured to the housing bottom piece 102 using a clamp 109 attached thereto by screws.

The housing 102, 103, also encloses a switch 112 that includes a spring means 113 to bias the switch 112 in an open (“OFF”) position by moving the conductive bridge 117 away from electrical contacts of hot wire 120a and switched hot wire 120b, which thereby moves plunger 116, which is attached to the conductive bridge 117, out of the housing 102, 103, and out of the switch 112. The switch 112 may be closed (“ON”) by moving the plunger 116 into the housing 102, 103, and into the switch 112. When the plunger 116 is moved, or depressed, into the switch 112 the conductive bridge 117 moves to position 111 to electrically connect the hot wire 120a, which is electrically connected to one of the prongs 105, 106, to the switched hot wire 120b, which is electrically connected to the electrically powered device 125, as part of cable 108. Thus, the plunger 116 is movable into and out of the housing 102, 103, as indicated by the arrow 116a. The plunger 116 is shorter than the prongs 105-107. Because the plunger 116 is shorter than the prongs 105-107 by a predesigned length, when the prongs 105-107 are manually inserted into electric power outlet 123 the prong 107 will first electrically connect to a ground receptacle 126 of electric power outlet 123, as described herein. Second, the prongs 105, 106, will electrically connect to the hot and neutral power receptacles of electric power outlet 123. At this instant, although the prongs 105, 106, are electrically connected to the electric power outlet 123 such that the hot wire 120a is powered, or electrified, and the neutral wire 122 is electrically connected to the neutral receptacle of the electric power outlet 123, the switched hot wire 120b is not powered, or electrified, and so power does not flow from the electric power outlet 123 through the plug 100 to the electrically powered device 125 because the plunger 116 is not yet moved into the housing 102, 103, to electrically couple switched hot wire 120b to hot wire 120a.

As the prongs 105-107 continue to travel into the receptacles of electric power outlet 123 during manual insertion, the plunger 116 makes contact with the plate 124 of the electric power outlet 123 and is depressed into switch 112 causing the attached conductive bridge 117 of plunger 116 to close by reaching position 111 to make electrical contact with both the hot wire 120a and switched hot wire 120b. This insertion of the prongs 105-107 closes the circuit between the electric power outlet 123 and the electrically powered device 125. When the switch 112 is closed light source 114 is illuminated to indicate that the switched hot wire 120b is powered and the electrically powered device 125 is ready for activation. The light source 114 may include an LED or a neon light source, for example. The plunger 116 may be made from a non-conductive material connected to conductive bridge portion 117. The electric power outlet 123 is typically supplied with power from the mains electrical supply MAINS provided by the facility where the electric power outlet 123 is installed.

Similarly, because the plunger 116 is shorter than the prongs 105-107 by a predesigned length, when the plug 100 is manually removed from electric power outlet 123 the spring means 113 will move the conductive bridge portion 117 away from the hot wire 120a and switched hot wire 120b contacts while moving the plunger 116 out of the switch 112. At this instant, although the prongs 105, 106, are electrically connected to the electric power outlet 123 such that the hot wire 120a is powered, or electrified, and the neutral wire 122 is electrically connected to the neutral receptacle of the electric power outlet 123, the switched hot wire 120b is not powered, or electrified, and so power does not flow from the electric power outlet 123 through the plug 100 to the electrically powered device 125 because the plunger 116 has moved out of the housing 102, 103. Next, the prongs 105, 106, will electrically disconnect from the hot and neutral power receptacles of electric power outlet 123 so that hot wire 120a will not be electrified, while the longest prong 107 is still connected to the ground receptacle 126 of electric power outlet 123. Finally the prong 107 will electrically disconnect from ground receptacle 126.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electric plug comprising:
a housing;
a cable attached to and extending from a first side of the housing, the cable comprising a plurality of electrically conductive wires;
a plurality of electrically conductive prongs extending from a second side of the housing, the plurality of electrically conductive prongs each configured to be electrically coupled to one of the electrically conductive wires and configured to be electrically coupled to a source of electric power when the prongs are inserted into an electric power outlet; and
an electric switch disposed within the housing, the electric switch configured to electrically couple at least one of the plurality of electrically conductive prongs to the cable.

2. The plug of claim 1, wherein the electric switch comprises a plunger extending from the second side of the housing, the plunger configured to electrically couple the at least one of the plurality of electrically conductive prongs to the cable when the prongs are inserted to the electric power outlet.

3. The plug of claim 2, wherein the electric switch is configured to electrically couple the at least one of the plurality of electrically conductive prongs to the cable after the plurality of electrically conductive prongs are electrically coupled to the source of electric power.

4. The plug of claim 3, wherein the plunger extends from the housing at a distance less than a distance that the prongs extend from the housing.

5. The plug of claim 4, wherein the plunger is configured to be depressed into the housing when the plurality of electrically conductive prongs are inserted into the electric power outlet.

6. The plug of claim 3, wherein the electric switch is configured to electrically decouple the at least one of the plurality of electrically conductive prongs from the cable before the plurality of electrically conductive prongs are electrically decoupled from the source of electric power.

7. The plug of claim 5, wherein the plunger is configured to be moved out of the housing when the plurality of electrically conductive prongs are removed from the electric power outlet.

8. The plug of claim 2, wherein the plunger is configured to close an electrical contact between the at least one of the prongs and the cable when the plunger is depressed.

9. The plug of claim 1, wherein the switch comprises a biasing means configured to move the plunger out of the housing when the plurality of electrically conductive prongs are electrically decoupled from the source of electric power.

10. The plug of claim 1, further comprising a light source configured to be illuminated when the electric switch electrically couples the at least one of the plurality of electrically conductive prongs to the cable.

11. An electric plug comprising:
a housing;
a plurality of conductive prongs and a plunger extending from the housing, wherein the prongs are fixed to the housing, the prongs extend further from the housing than the plunger, and wherein the plunger is movable into and out of the housing;
a cable attached to and extending from the housing, the cable comprising a plurality of electrically conductive wires; and
an switch disposed within the housing and attached to the plunger, the switch configured to electrically couple at least one of the conductive prongs to the cable when the plunger is moved into the housing and to electrically decouple the at least one of the conductive prongs from the cable when the plunger is moved out of the housing.

12. The plug of claim 11, wherein the prongs extend from the housing further than the plunger extends from the housing.

13. The plug of claim 11, further comprising a light source electrically connected to the switch and configured to be electrically connected to the at least one of the conductive prongs when the electric switch electrically couples the at least one of the conductive prongs to the cable.

14. The plug of claim 11, wherein the electric switch is configured to electrically couple the plurality of conductive prongs to the cable after the plurality of conductive prongs are electrically coupled to an electric power outlet and to electrically decouple the plurality of conductive prongs from the cable before the plurality of conductive prongs are electrically decoupled from the electric power outlet.

15. The plug of claim 11, wherein the plunger is configured to be moved into the housing when the plurality of conductive prongs are inserted into an electric power outlet and to be moved out of the housing when the plurality of conductive prongs are removed from the electric power outlet.

16. The plug of claim 11, wherein the plunger is configured to close electrical contacts between the at least one of the conductive prongs and the cable when the plunger is depressed and to open the electrical contacts between the at least one of the conductive prongs and the cable when the plunger is not depressed.

17. The plug of claim 11, further comprising a biasing means configured to open the switch when the plunger is not moved into the housing by manual force and to allow the plunger to be moved into the housing by manual force.

18. The plug of claim 15, wherein the electric power outlet is configured to provide electric power to the prongs when the prongs are inserted into the electric power outlet.
